(19) United States
(12) Patent Application Publication
(10) Pub. No.: US 2011/0056004 A1
(43) Pub. Date: Mar. 10, 2011

(54) Protective anatomical pads and methods of making

(75) Inventor: James J. Landi, Maplewood, NJ (US)

(73) Assignee: XO Athletic Co., Union, NJ (US)

(21) Appl. No.: 12/584,652

(22) Filed: Sep. 9, 2009

(51) Int. Cl. A41D 13/05; A41D 13/08; A41D 13/06; B29C 45/14

(52) U.S. Cl. 2/459; 2/16; 2/24; 264/257

(57) ABSTRACT

A protective padded garment includes one or more pads conforming to three-dimensional coordinate data representing the anatomical body part to be protected. The pads are designed from three-dimensional scanned images of the human anatomy and molded in situ with the garment to be worn.

### BACKGROUND OF THE INVENTION

The invention relates generally to pads for protecting the human anatomy from impact, as well as to methods of making padded garments and the associated pads.

Protective equipment such as shoulder pads, rib protectors, shin pads, hip pads, and thigh pads are commonly worn by participants in many types of sporting events for protection from impact resulting from contact with an object or another participant. Such protective equipment has been used by athletes in various contact sports such as football, hockey and soccer, as well as non-contact sports such as baseball, basketball, equestrian sports and the like. Protective pads such as knee and elbow pads are commonly used during activities such as skating, skateboarding, and cycling to protect against bodily injury during falls on the pavement or other hard surfaces.

Conventional protective pads typically include a relatively hard outer shell of a material such as plastic, as well as an inner layer of softer padding material. The hard outer layer is provided to receive the applied force or shock of an impact, and to distribute the force over a large area. The soft padding material, in addition to acting as a cushion for providing comfort to the wearer, usually acts to absorb and dampen the aforementioned forces in order to protect the wearer from the shock of an impact. However, despite the padding material, hard shell protective pads are often uncomfortable to wear due to their universal construction intended to accommodate different human anatomy types.

Protective equipment which incorporate various pad designs are commonly of two constructions. One type of protective equipment are garments constructed specifically for protecting selected portions of the wearer's anatomy by including strategically placed pockets constructed to receive a protective pad. Examples of such protective equipment are disclosed in U.S. Pat. Nos. 4,507,801; 6,145,134; 5,093,931; 6,357,054; 6,070,273; and U.S. Patent Application publication Nos. 2008/0127401 and 2009/0025126. The other type of protective equipment permanently adheres the protective pad to the garment surface at preselected locations where, depending upon the activity of the wearer, are those most likely to sustain an impact. Examples of such protective garments are disclosed in U.S. Pat. Nos. 4,810,559; 6,810,534; 7,100,216; and United States Patent Application Publication No. 2005/0039245 (assigned to the same assignee of the present invention).

Significant to the functionality of the aforementioned protective equipment is that the protective pads remain at their desired location while the wearer is participating in various activities. In contact sports, for example, it is not uncommon for the protective pads in known protective equipment to shift from their intended location. Upon such occurrence, the intended anatomy of the wearer to be protected may be exposed and left unprotected unless the pads are repositioned by the wearer. However, during various activities such as sports, the wearer may not notice shifting of the protective pad's position, or may be unable at the moment to reposition the pad. In such circumstances, this can lead to injury.

There is an unsolved need for a protective garment incorporating pads having a construction overcoming the drawbacks and limitations of the prior art. In particular, it is desirable to provide a protective garment having pads which remain stable at their intended location during the activity of the wearer, as well as being comfortable to wear and having a relatively simple construction lending itself to efficient, cost-effective and non-labor intensive manufacturing.

### BRIEF SUMMARY OF THE INVENTION

The invention is directed to protective pads incorporated into garments for protecting the elbows, knees, shins, shoulders and other anatomical areas of a person during a sports event or other activity. The pads are uniquely constructed as a three-dimensional body having one or more layers of synthetic or natural polymers, or other natural or synthetic materials suitable for use in a protective pad. The three-dimensional body conforms to a digitally scanned portion of the human anatomy such as the contours found around the knee or elbow of the wearer.

A three-dimensional mold for making the pad is constructed based upon three-dimensional data, i.e., X, Y, Z coordinate data obtained from scanning the relevant part of the human anatomy to be protected. The pad can be constructed from multiple layers of various materials, each layer having a specific property or characteristic, such as shock absorption, impact resistance, energy dissipation, and the like. The light weight nature of the pad may be maintained by coring out sections or quadroons of the pad which contain the other layers to provide the pad with its functional attributes.

The pad may be formed as a separate component apart from the garment to which the pad will be incorporated. In this regard, multiple pads can be manufactured and stored in inventory for later application to the final garment. In this regard, the pads can be manufactured in one location by one manufacturer and adhered to the garment in a separate process at a different location by another manufacturer. Pads can therefore be sold to a variety of garment manufacturers. The outer surface of the pads may be adorned with various graphics, logos, names, trademarks, or other indicia as may be desired by the wearer or in support of the manufacturers product.

In the preferred embodiment, the pads are formed simultaneously with their adherence to the garment to be worn. In this regard, the three-dimensional mold will include a cavity which receives a layer of the garment which functions as a permanent carrier for the pad. By injecting polymer material into the mold cavity, the pad is formed as an integral component with the garment layer. Upon donning the garment, the pad will find the human anatomy component to match up with and conform itself in place with minimal weight and bulk that is found in currently known pads. In the preferred embodiment, the garment is made from stretchable fabric to add to its custom fit to the human anatomy of the wearer who have different body sizes and shapes. The garment by being stretchable, allows for multiple pads to find their correct position on the human anatomy, such as on the lower leg and knee, regardless of the user size and weight.

A method of making a garment having a protective pad, the method comprising creating coordinate data representing a portion of a human anatomy; using the coordinate data to provide a mold having a cavity bound by at least first and second surfaces, the first surface conforming to the portion of the human anatomy; positioning a portion of a garment within the cavity; and supplying a first polymer material into the cavity to form a pad, the pad having an inner surface and an outer surface, the inner surface conforming to the portion of the human anatomy and adhering to the portion of the garment.

A method of making a garment having a protective pad, the method comprising: creating 3D data representing a portion of a human anatomy; using a mold having a cavity corresponding to the 3D data for making at least one pad having an inner surface and an outer surface, the inner surface conforming to the portion of the human anatomy; positioning a layer of material forming a portion of a garment within the cavity, and supplying a polymer material into the cavity whereby the polymer material forms the pad having the inner surface adhered to the layer of material.

A method of making a protective pad for use with a garment, the method comprising creating 3D data representing a portion of a human anatomy; using a mold having a cavity corresponding to the 3D data for making at least one pad having an inner surface and an outer surface; and supplying a first polymer material into the cavity thereby forming the pad, the pad having the inner surface conforming to the portion of the human anatomy.

A protective pad for use with a garment, the pad comprising a body of a first polymer material, the body having an inner surface and an outer surface, the inner surface having a profile corresponding to 3D data representing a portion of a human anatomy.

A garment having a protective pad, the garment comprising a layer of material; and a pad of a first polymer material comprising a body having an inner surface and an outer surface, the inner surface adhered to the layer and having a profile conforming to a portion of a human anatomy.

A garment having a protective pad, the garment comprising a layer of material; and at least one pad of a first polymer material comprising a body having an inner surface and an outer surface, wherein substantially the entire inner surface of the body is adhered to the layer of material, the inner surface having a three dimensional profile conforming to X, Y and Z coordinates representing a portion of a human anatomy.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is a perspective view of a protective pad adhered to a garment in accordance with one embodiment of the present invention.

FIGS. 2-7 are cross-sectional views of protective pads constructed in accordance with the various embodiments of the present invention.

FIG. 8 is a perspective view of a laser scanning system for creating three-dimensional data representing selected portions of the human anatomy.

FIG. 9 is a representation of the human anatomy created from the three-dimensional data obtained from the scanning process.

FIG. 10 is a cross-sectional view of a mold constructed in accordance with an embodiment of the present invention for manufacturing protective pads in accordance with the various embodiments of the present invention.

FIG. 11 is a front elevational view of a supporting layer having adhered thereto a protective pad according to the process and use of the mold as shown in FIG. 10.

FIG. 12 is a cross-sectional view of a mold constructed in accordance with an embodiment of the present invention for manufacturing protective pads in accordance with the various embodiments of the present invention.

FIG. 13 is a front elevational view of a supporting layer having adhered thereto a protective pad according to the process and use of the mold as shown in FIG. 11.

FIG. 14 is a perspective view of a plurality of exemplary protective pads adhered to a supporting layer forming a garment at pre-selected locations of the human anatomy.

FIGS. 15 and 16 are plan views of garments having a plurality of protective pads in accordance with the embodiments of the present invention.

### DETAILED DESCRIPTION OF THE PREFERRED EMBODIMENTS

In describing the preferred embodiments of the subject matter illustrated and to be described with respect to the drawings, specific terminology will be resorted to for the sake of clarity. However, the invention is not intended to be limited to the specific terms so selected, and needs to be understood that each specific term includes all technical equivalents which operate in a similar manner to accomplish a similar purpose. Referring to the drawings, the present invention will be described with respect to the miscellaneous embodiments, wherein like reference numerals represent like elements.

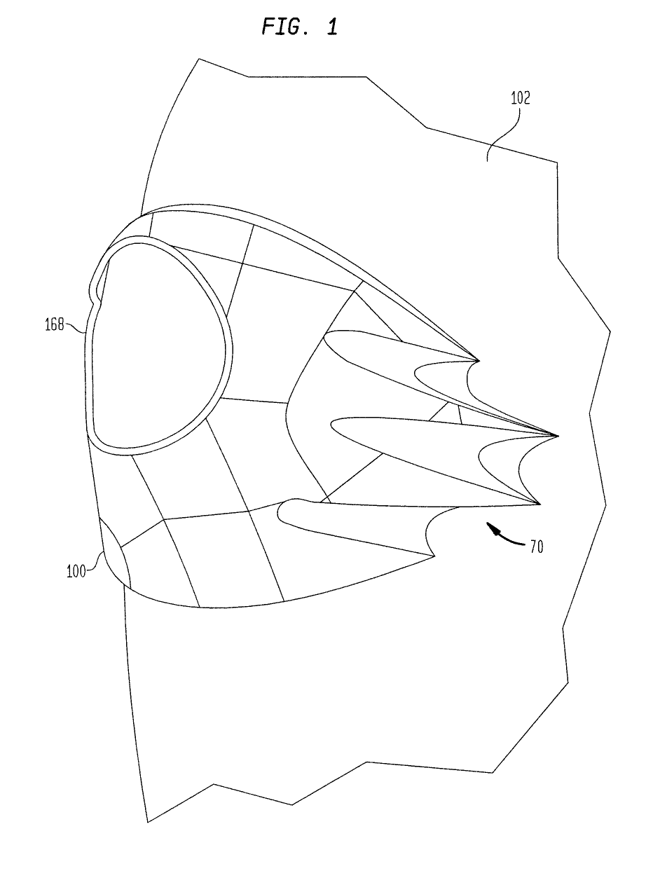

Referring to FIG. 1, there is illustrated in accordance with one embodiment of the present invention a protective pad 100 adhered to a portion of a supporting layer 102 such as a garment to be worn by the user during various activities.

The pad 100 can be constructed from one or more layers of various synthetic or natural polymers and/or natural occurring materials to provide the performance characteristics desired of the pad depending upon the activity of the wearer. For example, the pad 100 can be constructed from a single molded layer of synthetic polymer material having various hardnesses. Harder polymer material will provide greater protection against blunt impact from hard objects, while softer polymers will provide more shock absorption and dissipation. The pad 100 may include an inner layer of soft materials such as polymer gels which will function to dissipate impact forces to the pad, while providing a cushioning layer providing more comfort to the wearer. In addition, multilayer pads may include harder imbedded layers of polymer material or natural materials such as metal components to enhance the impact protective qualities of the pad. Regardless of the materials of construction of the pad 100, the inner surface layer of the pad will be constructed to conform to that portion of the human anatomy to be protected.

There will now be described various exemplary embodiments of a pad which is adapted to be adhered to a supporting layer such as a portion of a garment to be worn. As will be appreciated, the pad 100 can be constructed in a variety of sizes and shapes which may be dictated by functionality and aesthetics, as well as the size and shape of the various anatomical body parts. The pad of the present invention is constructed to have an inner surface layer which conforms to the anatomical body parts to be protected, thereby providing greater comfort to the wearer while enhancing the pad's ability to retain its position during activities of the wearer.

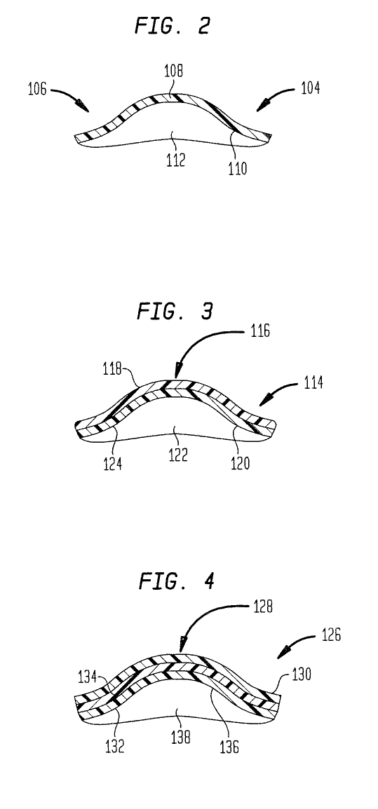

FIG. 2 illustrates a single layer in the form of a pad 104 constructed as a cup-shaped shell 106. The shell 106 is defined by a layer having an outer surface 108 and an inner surface 110 which defines a cavity region 112. The inner surface 110 is sized and shaped to conform to the anatomical body part to be protected which is received within the cavity region 112. The cup-shaped nature of the pad 104 lends the pad particularly suitable for protecting elbows and knees of the wearer.

By way of example, the shell 106 can be constructed from a variety of thermoplastic polymer materials, including rigid and semi-ridged material, such as polyurethanes, polyesters, nylon, thermoplastic olefins, thermoplastic elastomers such as styrenics block co-polymers, polycarbonates, polypropylenes, ethylene polymeric materials and the like. Thermoplastic polymers are preferred as they allow the pad to be manufactured using conventional injection molding techniques. However, it is contemplated that thermoset polymers can also be used in the construction of pads in accordance with the present invention, for example, vulcanized rubber, thermoset elastomers and urethanes or polymers that need a catalyst to curve.

Referring to FIG. 3, there is illustrated a pad 114 constructed in accordance with another embodiment of the present invention. The pad 114 is constructed from a composite shell 116 formed from an outer layer 118 overlying a contiguous inner layer 120. The outer and inner layers 118, 120 are substantially coextensive with each other defining a cavity region 122. The cavity region is bounded by the inner surface 124 of the inner layer 120 which conforms to the anatomical body portion intended to be protected by the pad 114.

The outer and inner layers 118, 120 can be constructed from different material compositions, such as having different hardnesses thereby having different shock absorbing and shock dissipating properties. By way of example, the outer layer 118 can be constructed from a relatively hard polymer, while the inner layer 120 can be constructed from a softer gel-like polymer material, such as those having twenty Shore A value or below, more preferably in the range of 3-5 Shore A. By constructing the inner layer 120 from a gel-like material, the pad 114 will provide a cushioning layer which will enhance the wearer's comfort, while providing for shock absorption and dissipation of impact to the pad. Suitable gel-like materials include thermoplastic elastomers, thermoplastic olefins and thermoplastic urethanes.

By constructing the inner and outer layers 118, 120 from different materials, the pad 114 can be tailored to specific activities of the wearer to provide the maximum protection against injury to the wearer's anatomy. This design flexibility and constructing the pad pursuant to the invention enhances its utility by being adaptable to the wearer's needs.

Referring to FIG. 4, there is illustrated a pad 126 constructed in accordance with another embodiment of the present invention. The pad is constructed as a composite shell 128 from three contiguous layers, i.e., outer layer 130, inner layer 132, and middle layer 134. The inner layer 132 is substantially coextensive with the middle layer 134, having an inner surface 136 defining a cavity region 138. As with the inner surfaces of pads 104, 126, the inner surface 136 is constructed to conform to the anatomical body portion intended to be protected by the pad.

Each of the layers may be constructed from different materials in the manner as previously described. By way of example, the middle layer 134 can be constructed from a relatively harder polymer composition to maximize protection from blunt impact to the pad by hard objects such as baseball bats, baseballs and the like. The outer layer 130 can be constructed from a softer polymer composition which will facilitate absorption and dissipation of the force of the impact. Further, the inner layer 132 can be constructed from a gel-like polymer material which provides a cushioning effect for the pad thereby enhancing wearer comfort, as well as facilitating dissipation of impact forces on the pad.

The pads pursuant to the invention as thus far described can be constructed from one or more layers of polymer or other natural or synthetic materials, which when combined, provide the requisite impact and shock absorbing properties necessitated by the wearer's activity. In addition, the pad can possess enhanced comfort and shock dissipation properties by incorporating an inner layer from gel-like material. In each case, the inner surface of the pad is constructed to conform to the anatomical body part to be protected. Such construction enhances wearer comfort of the pad, as well as enhancing the pad's ability to remain in its desired position during activity of the wearer.

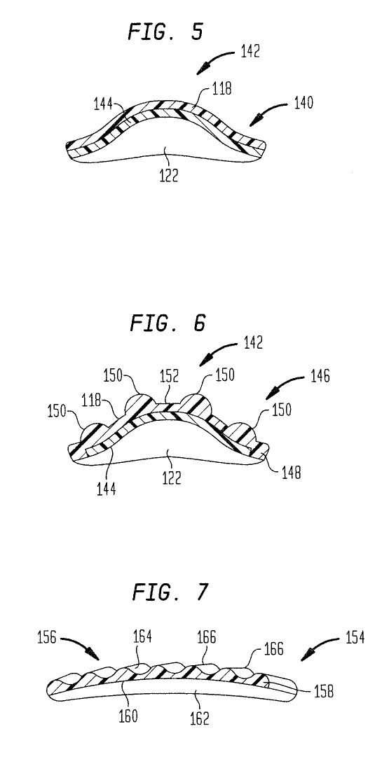

Turning to FIG. 5, there is illustrated a pad 140 formed as a shell 142 which is similar in construction to pad 114 as illustrated in FIG. 3. In this regard, the pad 140 includes an outer layer 118 and a contiguous inner layer 144. Unlike pad 114, the inner layer 144 is not coextensive with the outer layer 118. Although shown as a continuous inner layer 144, it is to be understood that this layer as well as the other inner layers described may be a discontinuous layer or one having open areas such as a pattern of holes of any desired geometric shape.

Turning to FIG. 6, there is illustrated a further embodiment of a pad 146 having a construction similar to pad 140 as shown in FIG. 5. The pad 146 is provided with a plurality of protrusions 150 projecting outwardly from the outer surface 152 of the outer layer 118. The protrusions may be formed from the same material as the outer layer 118 during the molding process. In this regard, the protrusions 150 and the outer layer 118 will be concurrently formed as an integral layer during manufacture. However, it is also contemplated that the protrusions 150 may be formed from a different polymer material to provide the pad 146 with different characteristics. In this regard, the protrusions 150 can be constructed from harder or softer polymer material from that of the outer layer 118.

The protrusions may be in the form of segmented bodies arranged in a random or predetermined pattern or array. The protrusions may be of any desired size and shape such as regular and irregular shaped spheres, elongated rod-like members, polygonal shape bodies, ribs, cylindrical bodies, semi-circular bodies, and the like. In addition, dimples may be incorporated into the pad with other structures such as the protrusions if desired.

The protrusions 150 can be adapted to provide the pad with a specific performance characteristic such as shock absorption, shock dissipation, abrasion resistance, etc. In addition, the protrusions can be arranged to provide the pad to have different areas or fields of performance as may be dictated by the activity of the wearer. For example, the protrusions 150 can be strategically placed to provide the pad with regions of greater stiffness and mass for greater protection of certain anatomical body parts, as well as for decorative purposes.

The pads as thus far described have been defined by a shell forming a cavity region for capturing anatomical body parts such as knees, elbows, and the like which lend themselves to pads having deep cavity regions. The pads of the invention are also suitable for protecting anatomical body parts where deep cavity regions are not necessitated. For example, one frequent anatomical body part which is protected is the shin during sports activities such as soccer. In those instances, a pad with shallow cavity regions to conform to the wearer's shin is desired.

Referring to FIG. 7, there is illustrated a pad 154 constructed in the form of a shell 156 from a single layer of a polymer composition having an inner surface 160 which defines a shallow cavity region 162. The inner surface 160 in the manner as previously described conforms to the anatomical body part to be protected by the pad 154. As the pad is intended to protect, for example, the wearer's shin, the cavity 162 is relatively shallow and extends over a greater body area than the cavity regions previously described with respect to the pads illustrated in FIGS. 2-6. As evident from the drawing, the pad 154 is flatter than the previously described pads, while still being constructed to include a cavity region 162 which enables placement of the pad about the shin of the wearer or other body part to be protected.

The pad 154 has an outer surface 164 which can be constructed as a generally smooth planar member, or may include a plurality of protrusions 166. The protrusions may be of similar construction and purpose as the protrusions 150 describe with respect to the pad illustrated in FIG. 6. By way of example as illustrated in FIG. 7, the protrusions are in the nature of parallel spaced apart ridges having peaks and valleys. This arrangement provides the pad 154 with flexibility along its longitudinal access in view of the valleys while providing structural rigidity in the transverse direction. The protrusions 166 provide enhanced protection against impact over a single more uniform layer.

It is also contemplated that the pads as thus far described are not required to be of solid construction. For example, as shown in FIG. 1, the pad 100 may include an opening 168 asymmetrically arranged with respect to the center of the pad. Thus, it is contemplated that various openings, of various sizes and shapes, can be formed within a pad as may be desired to conform the anatomical body part or to create greater flexibility in the pad or to enable positioning of the pad on the body part. In addition, the pad may include various shaped portions such as the wing shaped protrusions 170, or regions of different thickness.

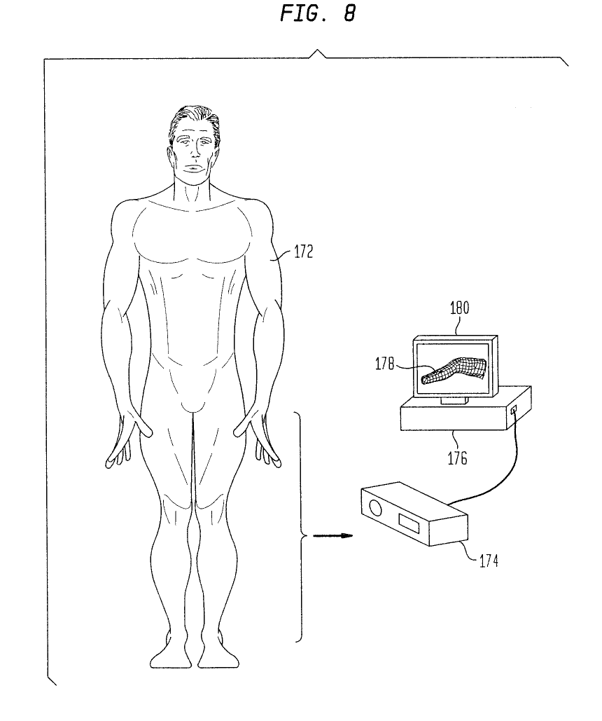

Referring now to FIGS. 8-11, there will be described one method of making the pad having an inner surface conforming to an anatomical body part in accordance with one embodiment of the present invention. As previously described, the construction of a pad which conforms to an anatomical body part renders the pad more comfortable for the wearer, as well as enhancing the ability of the pad to maintain its position for protecting the body part during activity of the wearer. For illustration purposes only, there will be described the method of making pad 104 as shown in FIG. 2 and pad 146 as shown in FIG. 6. Based upon the foregoing description, the described method may be used to construct pads of other constructions which embody the invention as described herein.

It is not a requirement of the present invention that the pads be custom fit to a particular wearer. In this regard, it is contemplated that typical anatomical body parts such as elbows, knees, shins, shoulders and the like are anatomically similar between male and female anatomies. These anatomical body parts are contemplated to differ in size based upon the height of the wearers. On this basis, it is possible to develop pads in different size ranges such as extra small, small, medium, large and extra large which will conform to the mass of intended wearer. Thus, extra small pads will conform to anatomical body parts of small children, while extra large pads will conform to the anatomical body parts of large adults. One can employ human models from young children to large adults as representative models of the appropriate size and shape of the desired anatomical body parts when designing the pads of the invention. It is therefore not necessary that the pads be custom fit to the wearer, although custom fitting is within the scope of the invention.

Referring to FIG. 8, a human model 172 has proportions for making large sized protective pads pursuant to the invention. The pad construction is based upon three-dimensional data, for example, X, Y and Z coordinate data, representative of the anatomical body part to which the pad conforms. Obtaining the three-dimensional data can be achieved using known system and techniques. For example, a digital laser scanning system 174 is used in accordance with the preferred embodiment. The laser scanning system works on the principal of laser triangulation. By making a triangle between the scanner lens, laser, the object being scanned, accurate three-dimensional data can be obtained. The distance between the scanner lense and laser is known, and with the angel of the laser given by a galvanometer, all information is provided to obtain X, Y, Z coordinates of the object surface being scanned. The laser is swept across the object by the galvanometer, which rotates a small mirror that reflects the laser. The surface of the object is then focused through the lense and captured by a CCD inside the scanner. A dense point cloud is produced through manipulation of the data via software. One such system is available from The 3D Digital Corp. of Sandy Hook, Conn., e.g., the ES-scan model.

The system 174 is operative for surface scanning approximately a four inch by four inch area. Accordingly, in order to scan the entire surface area of the anatomical body part of interest, either the system is moved about the body part to affect a complete scan, or where the scanning system is held stationary, the person is rotated in front of the laser to affect complete scan coverage. In either event, the scanning process creates blocks of 3D data representative of each of the separate scans. In order to effectively provide a three-dimensional representation of the object, the data is processed with software, such as SLIM 3D software by 3D-Shape of Germany. The SLIM software merges and aligns scans together based on common feature recognition between scans, and then registers the scans globally as one 3D model. As long as there is an overlap and common features among two scans, the software can automatically align the data. If not enough crossover or common features between the scans, markers are used in software to align and merge the scans. The software also smoothes, fills holes, and refines the scans to give a clear image of the model. The resulting 3D digital model is easily exported into popular 3D software formats and edited and manipulated using third party application software, such as CAD software.

Turning again to FIG. 8, the system 174 is coupled to a computer 176 for processing of the scan data and creating therefrom a three-dimensional image 178 which is displayed on a monitor 180 representative of the X, Y and Z coordinates of the scanned image. The three-dimensional data representing the anatomical body part can be obtained using other technologies. For example, it is contemplated that a coordinate measuring machine (CMM) can be used. A CMM is a device for measuring the physical geometrical characteristics of an object. The machine may be manually controlled by an operator or it can be used on a computer control. Measurements are defined by a probe attached to a third moving axis of the machine. The probe may be mechanical, optical, laser, or white light. One such CMM is available from Brown & Sharp of North America, Mitutoyo of Japan and Starrett of North America. Other techniques include a casting process whereby settable material is formed around the anatomical body part and set to create a mold when separated. Additionally, the three-dimensional data can be obtained using hand measurements.

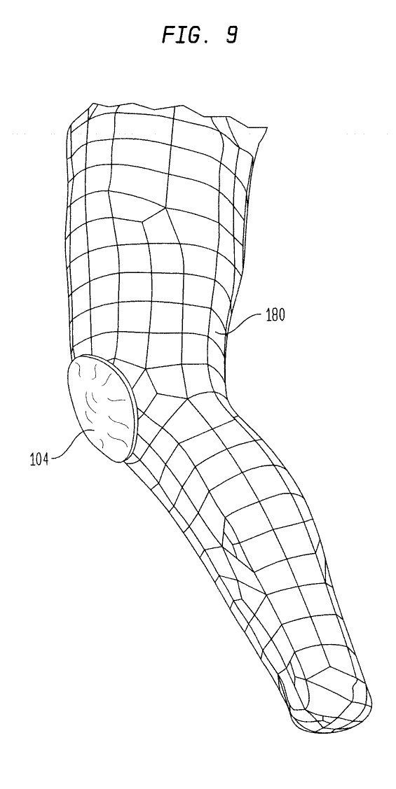

Turning to FIG. 9, CAD software is used to design the pad 104 that conforms to the three-dimensional surface of the image 178. The pad 104 can therefore be designed with any of the attributes as thus far described with respect to the various embodiments of a pad pursuant to the invention. Suitable CAD software can be obtained from Solidworks of Concord, Mass. and Parametric Technology Corp. of Needham, Mass.

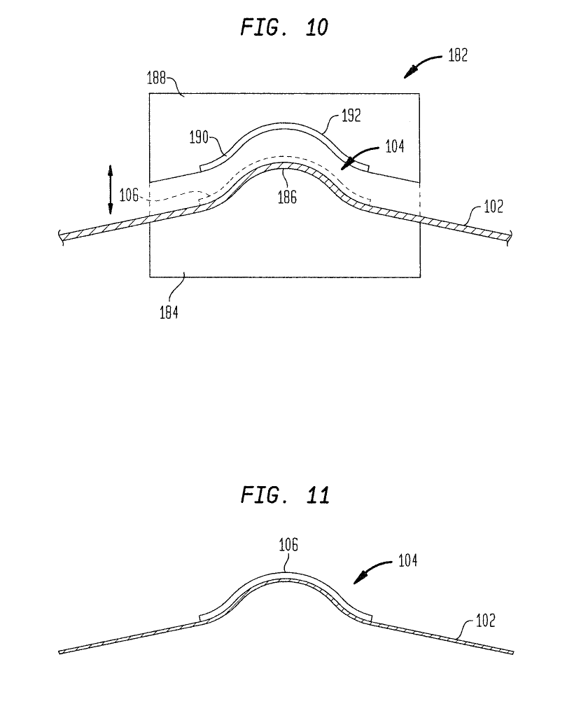

The three-dimensional CAD data of the pad 104 is used for creating a mold 182 as shown in FIG. 10. The mold includes a core side or “B” side 184 whose inner surface 186 has the profile corresponding to the three-dimensional data of the scanned anatomical body part. Opposing the core side 184 is a cavity side or “A” side 188 having a cavity 190. The cavity 190 defines the structure of the shell 106 of the pad 104. The cavity's inner surface 192 defines the profile of the outer surface of the pad 104. In its simplest form, the pad has a shell formed as a single layer of uniform thickness, although varying thicknesses are contemplated. The two-part mold can be constructed from known manufacturing techniques to enable injection of thermoplastic material into the cavity 190 to form the pad 104.

During the molding process, the molded pad 102 is adhered to a supporting layer 102 which forms a portion of the garment to be worn. In the preferred embodiment, the supporting layer can be a woven or non-woven resilient material having elastic properties from synthetic polymer materials such as elastane, however, other polymer materials such as polyesters, nylon, and the like which have stretchable Or non-stretchable characteristics may be used. Other examples include natural fabrics such as cotton and wool; and combinations of synthetic and natural materials. In addition, it is contemplated that natural materials such as cotton can be used for the supporting fabric layer 102. As the pad 102 adheres to the supporting layer during the molding process, it is preferred that the supporting layer be a synthetic polymer of the thermoplastic type.

When the mold 182 is open, the supporting layer 102 is positioned overlying and in contact with the inner surface 186 of the core side 184 of the mold. The supporting layer, in the preferred embodiment, will be that portion of the garment to which the pad 104 is to be adhered. However, it is contemplated that the supporting layer can be a separate material which is subsequently adhered to the garment by any conventional means such as stitching, gluing, thermal bonding or the like. Once the supporting layer has been positioned within the mold 182, the mold is closed as indicated by the dashed lines in FIG. 10. Subsequent, the thermoplastic composition forming the pad 104 is injected into the cavity 190. The polymer material fills the cavity 190 and flows over the outer surface of the supporting layer 102 which is contiguous with the cavity.

Upon separation of the mold halves, the inner surface 110 of the pad 104 is integrally and coextensively bonded to the surface of the supporting layer 102. The one step molding process produces the finished pad, while at the same time, adhering the pad to the supporting layer. The completed pad 104 is illustrated in FIG. 11 with the supporting layer 102 coextensively adhered thereto.

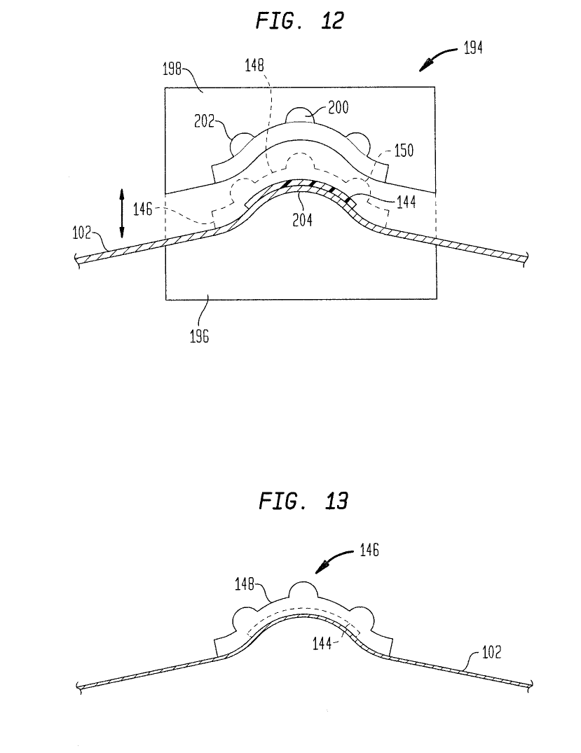

Turning to FIG. 12, the pad 146 is fabricated in a similar injection molding process via a mold 194 having a core side 196 and a cavity side 198. The cavity side 198 is provided with a cavity 200 conforming to the shape of the shell 148 which forms the pad. As shown, the cavity inner surface 202 has an irregular shape so as to define the protrusions 150 in the resulting pad. The inner surface 204 of the core side 196 has a shape and dimension corresponding to the three-dimensional coordinate data representative of the anatomical body part desired in the pad.

The supporting layer 102 is placed within the mold in contact with the inner surface 204 of the core side 196. A pre-formed inner layer 144 is placed within the mold over the supporting layer 102 underlying the cavity 200. The inner layer 144 can be constructed from a variety of materials. For example, the inner layer 144 can be formed from a gel-like polymer material which provides a soft cushioning layer to the resulting pad, as well as providing a shock absorbing and dissipating layer. It is contemplated that the gel composition will enable the inner layer 144 to conform to the inner surface 204 of the core side 196 when positioned over the supporting layer. It is not a requirement that an inner layer 144 of a gel-like material generally be preformed to conform to the shape of the inner surface 204.

The inner layer 144 can thus comprise any number of materials such as soft gels, harder thermoplastic or thermo-set polymer materials, non-polymeric materials and the like. It is only generally required that the material composition of the inner layer having a melting temperature high enough so as not to melt and loose its shape during the injection molding process. In the case where the inner layer 144 is a hard or rigid polymer or non-polymeric material, it is generally preferred that the inner layer be pre-molded into a layer having a shape conforming to the inner surface 204, i.e., conforming to the three-dimensional coordinate data representative of the anatomical body part.

After the mold 194 has been closed, the polymer material is injected into the cavity 200 forming the shell 148 which encapsulates the inner layer 144 except for the side overlying the supporting layer 102. It is contemplated that the inner layer 144 as a result of the heat applied during the molding process will result in the inner layer adhering also to the support layer 102. However, it is not a requirement of the invention that there be adhesion, as the remaining area of the shell 148 surrounding the inner layer 144 adheres to the supporting layer. The resulting pad 146 adhered to the supporting layer 102 is illustrated in FIG. 13.

It is contemplated that the pads of the invention can be fabricated separately from the supporting layer. The pads can be separately produced and inventoried for later adherence to a supporting layer such as a garment. In this regard, the pad can be subsequently adhered to the garment using any suitable techniques such as adhesive bonding, thermal bonding, stitching and the like. Examples of adhereing a pad to a garment are disclosed in U.S. Patent Application Publication No. 2005/0039245, the disclosure of which is incorporated herein by reference.

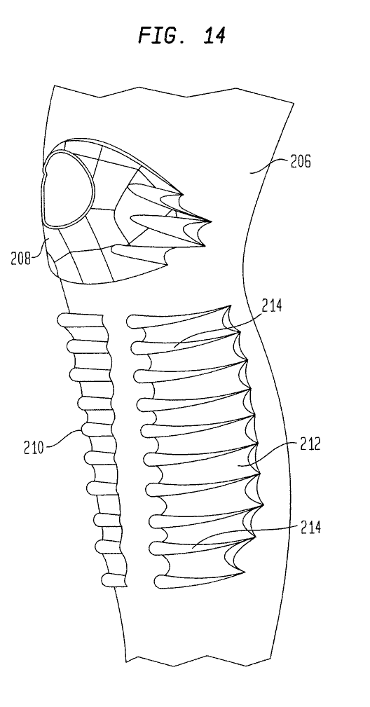

Referring to FIG. 14, there is illustrated a portion of a garment 206 to which a plurality of pads pursuant to the invention are adhered at pre-selected locations. For illustrative purposes, the garment 206 is in the nature of a pair of stretchable leggings of elastane materials. A knee pad 208 is adhered to that portion of the garment which will align with the wearer's knee. A pair of spaced apart shin pads 210, 212 is adhered to the garment 206 below the knee pad 208 at locations to provide maximum protection for the wearer's shin. Shin pad 210 is of similar construction to pad 154 as shown in FIG. 7. Shin pad 212 includes a plurality of spaced apart parallel arranged tapered projections 214. Although the shin pad is illustrated as two pads 210, 212, it is contemplated that a single shin pad may be provided. However, the use of a split or separate shin pads allows for expansion of the pad to accommodate differences in size of the wearer.

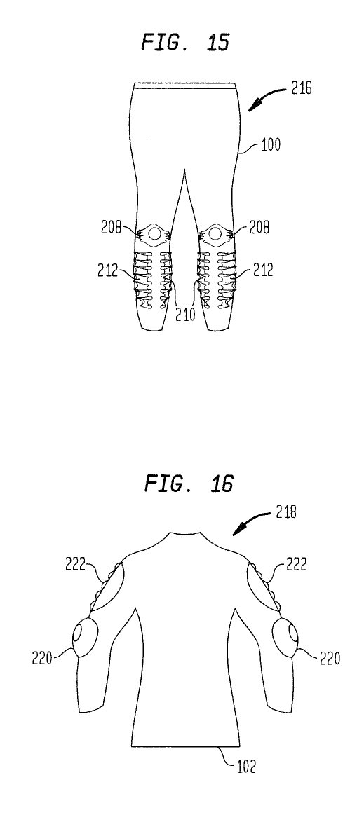

Turning to FIGS. 15 and 16, there are illustrated completed protected padded garments in the nature of leggings 216 and a shirt 218. The leggings, as previously described, include a supporting layer 102 to which there is affixed a knee pad 208 and shin pads 210, 212. The shirt 218 includes elbow pads 220 and shoulder pads 222.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of making a garment having a protective pad, said method comprising:
creating coordinate data representing a portion of a human anatomy;
using said coordinate data to provide a mold having a cavity bound by at least first and second surfaces, said first surface conforming to said portion of said human anatomy;
positioning a portion of a garment within said cavity; and
supplying a first polymer material into said cavity to form a pad, said pad having an inner surface and an outer surface, said inner surface conforming to said portion of said human anatomy and adhering to said portion of said garment.

2. The method of claim 1, wherein said creating said coordinate data comprises scanning said portion of said human anatomy with a laser, and responsive to said scanning, creating X, Y and Z coordinates corresponding to the surface of the scanned portion of said human anatomy.

3. The method of claim 1, wherein substantially the entire inner surface of said pad is adhered to said portion of said garment.

4. The method of claim 1, further including providing a preformed body overlying said portion of said garment within said cavity, said body formed from a second polymer material different from said first polymer material, said body having a portion forming said inner surface of said pad.

5. The method of claim 1, further including providing a layer of gel material within said cavity adjacent said portion of said garment, said layer of gel material having a portion forming said inner surface of said pad.

6. A method of making a garment having a protective pad, said method comprising:
creating 3D data representing a portion of a human anatomy;
using a mold having a cavity corresponding to said 3D data for making at least one pad having an inner surface and an outer surface, said inner surface conforming to said portion of said human anatomy;
positioning a layer of material forming a portion of a garment within said cavity, and
supplying a polymer material into said cavity whereby said polymer material forms said pad having said inner surface adhered to said layer of material.

7. The method of claim 6, wherein said creating said 3D data comprises scanning said portion of said human anatomy with a laser, and responsive to said scanning, creating X, Y and Z coordinates corresponding to the surface of the scanned portion of said human anatomy.

8. The method of claim 6, wherein said cavity includes a first surface opposing a second surface, said first surface defining said inner surface of said pad and said second surface defining said outer surface of said pad.

9. The method of claim 6, wherein substantially the entire inner surface of said pad is adhered to said layer of material.

10. A method of making a protective pad for use with a garment, said method comprising:
creating 3D data representing a portion of a human anatomy;
using a mold having a cavity corresponding to said 3D data for making at least one pad having an inner surface and an outer surface; and
supplying a first polymer material into said cavity thereby forming said pad, said pad having said inner surface conforming to said portion of said human anatomy.

11. The method of claim 10, wherein said 3D data comprises X, Y and Z coordinate data obtained by scanning said portion of said human anatomy with a laser.

12. The method of claim 10, wherein said cavity includes a first surface opposing a second surface, said first surface defining said inner surface of said pad and said second surface defining said outer surface of said pad.

13. The method of claim 10, further including providing a preformed body into said cavity, said body formed from a second polymer different from said first polymer, said body having a portion forming said inner surface of said pad.

14. The method of claim 10, further including providing a layer of a gel material within said cavity having a portion forming said inner surface of said pad.

15. A protective pad for use with a garment, said pad comprising:
a body of a first polymer material, said body having an inner surface and an outer surface, said inner surface having a profile corresponding to 3D data representing a portion of a human anatomy.

16. The pad of claim 15, wherein said 3D data comprises X, Y and Z coordinate data.

17. The pad of claim 15, wherein said body comprises a first layer of said first polymer material adjacent said outer surface and a second layer of a second polymer material adjacent said inner surface, said first polymer material being different than said second polymer material.

18. The pad of claim 15, further including a layer of a gel forming said inner surface of said body.

19. The pad of claim 15, wherein said outer surface of said body includes at least one protrusion.

20. The pad of claim 19, further including a plurality of protrusions comprising ribs.

21. A garment having a protective pad, said garment comprising:
a layer of material; and
a pad of a first polymer material comprising a body having an inner surface and an outer surface, said inner surface adhered to said layer and having a profile conforming to a portion of a human anatomy.

22. The garment of claim 21, wherein said layer of material comprises stretchable material.

23. The garment of claim 21, wherein said body comprises a first layer of said first polymer material adjacent said outer surface and a second layer of a second polymer material adjacent said inner surface, said first polymer material being different than said second polymer material.

24. The garment of claim 21, further including a layer of a gel forming said inner surface of said pad.

25. The garment of claim 21, wherein said outer surface of said pad includes at least one protrusion.

26. The garment of claim 25, further including a plurality of protrusions comprising ribs.

27. The garment of claim 21, further including a plurality of said pads adhered to said layer, each of said pads having an inner surface having a profile conforming to a portion of a human anatomy.

28. The garment of claim 21, wherein said profile conforms to X, Y and Z coordinates representing said portion of said human anatomy.

29. A garment having a protective pad, said garment comprising:
a layer of material; and
at least one pad of a first polymer material comprising a body having an inner surface and an outer surface, wherein substantially the entire inner surface of said body is adhered to said layer of material, said inner surface having a three dimensional profile conforming to X, Y and Z coordinates representing a portion of a human anatomy.

30. The garment of claim 29, wherein said layer of material comprises stretchable material.

31. The garment of claim 29, wherein said body comprises a first layer of said first polymer material adjacent said outer surface and a second layer of a second polymer material adjacent said inner surface, said first polymer material being different than said second polymer material.

32. The garment of claim 29, further including a layer of a gel forming said inner surface of said pad.

33. The garment of claim 29, wherein said outer surface of said pad includes at least one protrusion.

34. The garment of claim 33, further including a plurality of protrusions comprising ribs.

35. The garment of claim 29, further including a plurality of said pads adhered to said layer, each of said pads having an inner surface having a profile conforming to a portion of said human anatomy.

36. A method of making a protective pad for use in protecting the human anatomy, said method comprising:
creating coordinate data representing a portion of a human anatomy;
using a mold having a cavity corresponding to said data for making a pad having an inner surface and an outer surface;
supplying a first polymer material into said cavity thereby forming an outer layer of said pad; and
supplying a second polymer material into said cavity thereby forming an inner layer of said pad, said inner layer forming said inner surface conforming to said portion of said human anatomy.

37. The method of claim 36, wherein said supplying said second polymer material comprises providing a preformed body into said cavity, said body formed from said second polymer different from said first polymer, said body having a portion forming said inner surface of said pad.

38. The method of claim 37, wherein said preformed body comprises a layer of a gel material.

39. The method of claim 37, wherein said first polymer material has a hardness different from them hardness of said second polymer material.

40. The method of claim 36, wherein said creating said coordinate data comprises scanning said portion of said human anatomy with a laser, and responsive to said scanning, creating X, Y and Z coordinates corresponding to the surface of the scanned portion of said human anatomy.

41. A protective pad for use in protecting the human anatomy, said pad comprising:
a first body of a first polymer material; and
a second body of a second polymer material, said second body including an inner surface having a profile corresponding to coordinate data representing a portion of a human anatomy.

42. The pad of claim 41, wherein said coordinate data comprises X, Y and Z coordinate data.

43. The pad of claim 42, wherein said first body comprises a first layer forming an outer surface of said pad, and said second body comprises a second layer forming said inner surface of said pad, said first polymer material being different than said second polymer material.

44. The pad of claim 42, wherein said second body comprises a preformed body of gel material.

45. An article having a protective pad, said article comprising:
a layer of material; and
a pad comprising a first body of a first polymer material, a second body of a second polymer material having an inner surface, said inner surface of said second body adhered to said layer and having a profile conforming to a portion of a human anatomy.

46. The article of claim 45, wherein said layer of material comprises stretchable material.

47. The article of claim 45, wherein said second body comprises a preformed body of a gel material.

48. The article of claim 45, wherein said profile conforms to X, Y and Z coordinate data representing said portion of said human anatomy.
